(19) United States
(12) Patent Application Publication
(10) Pub. No.: US 2025/0379780 A1
(43) Pub. Date: Dec. 11, 2025

(54) GENERATIVE ARTIFICIAL INTELLIGENCE (AI) BASED SYSTEMS AND METHODS FOR NETWORK INCIDENT ANALYSIS

(71) Applicant: DISH Wireless L.L.C., Littleton, CO (US)

(72) Inventors: Sumugam Balachandran, Frisco, TX (US); Nidhi Kalpen Gandhi, Littleton, CO (US); Balarama Mathukumilli, Castle Pines, CO (US)

(21) Appl. No.: 19/232,993

(22) Filed: Jun. 10, 2025

Related U.S. Application Data
(60) Provisional application No. 63/658,316, filed on Jun. 10, 2024.

(51) Int. Cl. H04L 41/0631; G06F 40/205; G06F 40/30; G06F 40/40; H04L 41/069; H04L 41/16

(52) U.S. Cl. CPC H04L 41/0631; G06F 40/205; G06F 40/30; G06F 40/40; H04L 41/069; H04L 41/16

(57) ABSTRACT

Systems, devices, and methods related to network incident analysis. An example method includes: receiving historical RCA documents specific to a network service provider, receiving network data associated with the RCA documents, processing the RCA documents to generate RCA data based on the RCA documents and the network data, generating one or more vectors based on the RCA data and the network data, constructing and training one or more AI/ML models based on the RCA data and the vectors, receiving a query from a network operator of the network service provider, identifying one or more of the historical RCA documents pertaining to the query using the AI/ML models, analyzing the query using the AI/ML models to extract one or more intents of the network operator, generating contents using the AI/ML models, and generating a response comprising the contents for output.

### CROSS REFERENCE TO RELATED APPLICATIONS

This application claims priority to U.S. Provisional Patent Application No. 63/658,316, filed on Jun. 10, 2024, the disclosure of which is incorporated by reference in its entirety for all purposes.

### BACKGROUND

An operator or administrator of a network service provider needs to monitor the network to detect and identify network incidents, network anomalies, abnormal network conditions and performance, such as a deviation from normal usage and behavior of the network. Once detected, a root cause analysis (RCA) typically follows, including a deeper exploration into the root cause(s) of those anomalies, which helps the operator fix the underlying problem. Conventionally, RCA is performed by operators of the network service provider, and RCA documents are produced manually by the operators to report the detected anomalies.

### BRIEF SUMMARY OF THE DISCLOSURE

In an embodiment, computer system may include one or more processors. The computer system may also include a computer-readable storage media storing computer-executable instructions, where the computer-executable instructions, when executed by the one or more processors, cause the computer system to receive historical root cause analysis (RCA) documents specific to a network service provider. The computer system may receive network data associated with the RCA documents. The computer system may process the RCA documents to generate RCA data based on the RCA documents and the network data. The computer system may generate one or more vectors based on the RCA data. The computing system may construct and train one or more AI models based on the RCA data.

In some embodiments, instructions when executed further cause the computer system to receive a query from a network operator of the network service provider. The computing system may identify one or more of the historical RCA documents pertaining to the query using the AI models. The computing system may analyze the query using the AI models to extract one or more intents of the network operator. The computing system may generate contents using the AI models, the contents having data associated with the identified historical RCA documents and pertaining to the extracted intent. The computing system may generate a response having the contents for output. The computing system may receive a query from a network operator of the network service provider, the query indicating a suspicious network incident and including network data pertaining to the suspicious network incident. The computing system may identify one or more network incidents using the AI models, based on the network data. The computing system may determine one or more root causes of the identified/verified network incidents using the AI models. The computing system may recommend one or more actions to resolve the network incidents. The computing system may generate a response for output.

In an embodiment, a method may include receiving, by a computing system, an error log indicating an error within a cellular network. The method may also include providing, by the computing system, the error log to a machine learning module (MLM), the MLM configured to determine a root cause of the error. The method may include parsing, by the MLM, the error log to identify one or more datapoints. The method may include determining, by the MLM, a root cause of the error by utilizing the one or more datapoints as inputs to an artificial intelligence engine configured to associate the one or more datapoints with the root cause. The method may include determining, by the MLM, a corrective action to be taken such that the error may be corrected. The method may include outputting, by the computing system, data indicating at least one of the error, the root cause, or the corrective action.

In some embodiments, the MLM may include at least one of a large language model or a vector support machine. Method where the artificial intelligence engine may include a neural network. The error log may include at least one of geographic data, software data, hardware data, user equipment (UE) data, an error type, or an error rate. The method may include receiving, by the computing system, retraining data based at least in part on the data indicating at least one of the error, the root cause, or the corrective action. The method may include providing, by the computing system, the retraining data to the MLM such that one or more nodes of the MLM may be reconfigured, and an accuracy of the MLM may be increased when determining a future root cause. The MLM may include a large language model (LLM), the method may include receiving, by the computing system, a training dataset having historical error logs. The method may include generating, by the computing system, a modified training dataset where the modified training dataset may include transformed data of the training dataset. The method may include vectorizing, by the computing system, the training dataset and the modified training dataset to generate a preprocessed dataset. The method may include providing, by the computing system, the preprocessed dataset to the MLM such that an accuracy of the LLM may be increased when parsing a future error log. The method may include generating, by the MLM, instructions based at least in part on the output indicating the corrective action; and transmitting, by the computing system, the instructions to one or more network components such that upon execution of the corrective action, at least a portion of the root cause may be resolved. The MLM may include a generative AI model. The method may include determining, by the MLM, one or more network components associated with the root cause. The method may include determining, by the MLM, a respective entity associated with each of the one or more network components. The method may include transmitting, by the computing system, the data to the respective entities.

### BRIEF DESCRIPTION OF THE DRAWINGS

FIG. 1 is a block diagram illustrating an example communications system, according to various embodiments of the present disclosure.

FIG. 2 is a flow diagram illustrating an example method for network analysis, according to various embodiments of the present disclosure.

FIG. 3 is a flow diagram illustrating an example method for constructing and training an artificial intelligence/machine learning (AI/ML) model, according to various embodiments of the present disclosure.

FIG. 4A is a flow diagram illustrating an example method for automatic network incident analysis, according to various embodiments of the present disclosure.

FIG. 4B is a flow diagram illustrating an example method for automatic network incident identification and root cause analysis, according to various embodiments of the present disclosure.

FIG. 5 illustrates an example computer system or computer device, according to various embodiments of the present disclosure.

### DETAILED DESCRIPTION OF THE DISCLOSURE

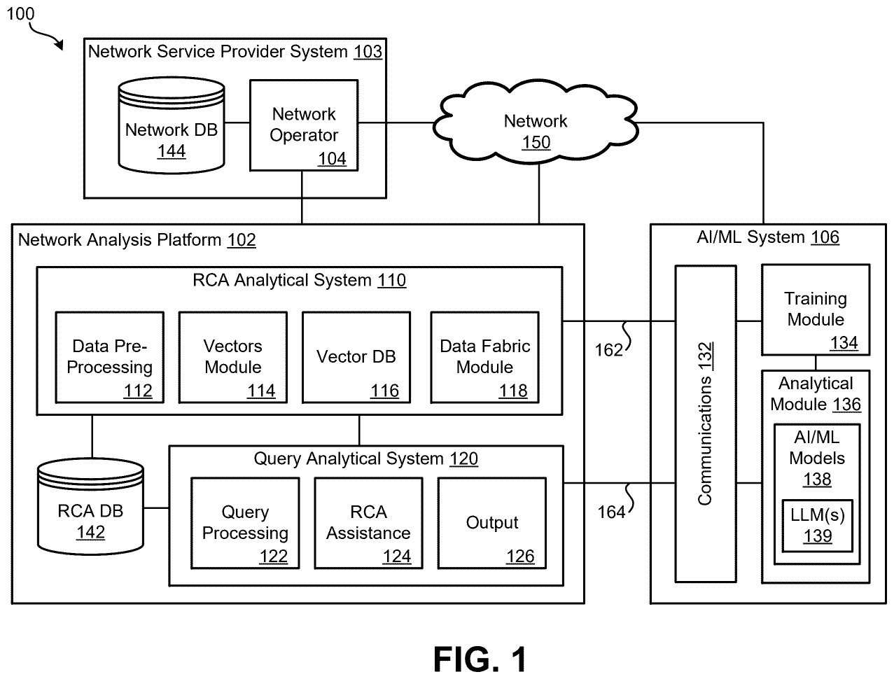

FIG. 1 is a block diagram illustrating an example communications system 100 (hereinafter “system 100”), according to various embodiments of the present disclosure. In the illustrated example, system 100 includes, among other components, a network analysis platform 102, a network service provider system 103, network operator(s) 104, AI/ML system 106, network database 144, and communications network 150. Additional or few components may be included in system 100. Each component of the systems described herein may include a hardware component such as a device, a server, an electronic processor, or any combinations thereof, a software component such as an engine, a module, a program, a service, an application, an application package, a cloud-based service or application, etc., or a combination of hardware and software components configured and operable to perform the intended functions.

The network analysis platform 102 may be implemented by a network management service, networking service, network monitoring and/or control service, network security service, network service provider, internet service provider, or any other network services. In some embodiments, one or more aspects of the system 100 may be enabled by a web-based software platform operable on a web server or distributed computing system. The network analysis platform 105 may perform all or part of the method, but can additionally or alternatively perform any other suitable functionality.

In the illustrated example, the network analysis platform 102 further includes, among other components, an RCA analytical system 110, a query analytical system 120, and an RCA database 142. At a high level, the RCA analytical system 110 is operable and configured to receive RCA documents (e.g., historical RCA documents provided by and specific to a network service provider), receive network data associated with the RCA documents, analyze the RCA documents and/or the associated network data to generate RCA data, and send the RCA data to the AI/ML system 106 for constructing one or more AI/ML models 138. The RCA documents may be pre-established by the network operator 104.

The network operator 104 may be one or more agents of a specific network service provider. The network service provider may implement a cloud-based 5G standalone open radio access (O-RAN) cellular network. In some embodiments, the network operator may operate a server within a network service provider system 103. The network operator 104 is authorized to access the network analysis platform 102 and communicate/interact with the components thereof, such as sending the RCA documents to the RCA analytical system 110, sending queries to the query analytical system 120, receiving a response to the query, receiving an RCA output from the query analytical system 120, etc.

At a high level, the query analytical system 120 is operable and configured to employ an AI-based assistance tool (e.g., using the AI/ML model developed by the AI/ML system 106) to respond to the query. In some embodiments, the query analytical system 120 can receive a query (e.g., a prompt or command from the network operator), analyze the query, identify relevant information pertaining to the query, generate a response, and output the response. In some embodiments, the query indicates a suspicious network incident, the query analytical system 120 can verify the suspicious incident or identify one or more anomalies associated with the network incident, determine root cause(s) of the network incident, recommend actions to resolve the incident, and generate an RCA output, using the AI/ML model. Various data and information related to the RCA, such as the RCA documents, RCA data, RCA output, etc., can be stored in the RCA database within the network analysis platform 102.

The network database 144 is configured to store network data associated with network services provided by the network service provider. Non-limiting examples of the network data may include network usage data, network condition data, Quality of Service (QOS) data, network performance metrics data, network infrastructure data, and other network data associated with a network service provided to and consumed by one or more customers of the network service provider.

At a high level, the AI/ML system 106 is operable and configured to receive RCA data from the RCA analytical system 110, construct, develop, train, and validate one or more AI/ML models 138 (e.g., large language models (LLMs) 139) using the RCA data, and provide access to the AI/ML models 138 to authorized parties (e.g., the network operators) to use the AI/ML models 138 on the network analysis platform 102. In some embodiments, the AI/ML system 106 is independent of the network analysis platform 102 and the network service provider. Alternatively, the AI/ML system 106 may be integrated to the network analysis platform 102 or any components thereof and co-operated by the network service provider. In some embodiments, the network analysis platform 102 and the AI/ML system 106 are implemented on one or more cloud computing platforms. The network analysis platform 102 and the AI/ML system 106 may reside in the same or different cloud. In some embodiments, the AI/ML system 106 may be implemented in a secured cloud environment. Transmission of data between the network analysis platform 102 and the AI/ML system 106 may be protected using secured protocols.

Network 150 can be a mobile network, cellular network, wireless network, wireless spectrum network, or any other type of a communications network. In some embodiments, the network 150 is Internet. The network 150 may utilize any known and/or later arising communications and/or networking technologies, standards, protocols or otherwise. Non-limiting examples of such technologies include packet switch and circuit switched communications technologies, such as and without limitation, Wide Area Networks (WAN), Local Area Networks (LAN), 3G/4G/5G/6G or other cellular networks, Internet of Things (IoT) networks, cloud-based networks, private networks, public networks, or otherwise.

In the illustrated example of FIG. 1, the RCA analytical system 110 further includes, among other components, a data pre-processing module 112, a vectors module 114, a vector database, and a data fabric module 118. The term “module” used herein refers to a modular and self-contained component or unit, often with defined inputs and outputs, configured to perform a specific function or set of related functions within a larger system. A module can be composed of hardware components, software code, or a combination of both. In some embodiments, the module described here is a device comprising a hardware component and a software component configured to perform the intended function of the module.

The data pre-processing module 112 is configured and operable to receive RCA documents and/or network data from the network service provider system 103. As mentioned above, the RCA documents are pre-established and specific to a network service provider. For example, an RCA document may outline aspects of a network incident and contain information including but not limited to the anomaly/problem statement, the root cause analysis, the impact analysis, the timeline for the incident, the troubleshooting steps, and recommendations for preventing the same or similar anomalies related to the network incident. The data pre-processing module 112 is further configured to process the pre-established RCA documents, extract relevant information and features from the RCA documents and data streams, eliminate irrelevant or redundant information, generate RCA data, standardize the data formats of the RCA data, and validate the RCA data. RCA data may include textual data, image data, numerical data, among others. The RCA data may further include feature data, insight data, and other data derived from the RCA documents. The RCA documents and RCA data are stored in the RCA database 142, which may be secured and accessible by only authorized parties (e.g., authorized network operators). In some embodiments, the feature related to an anomaly/incident may include incident type, frequency of the incident, incident cause, geographical location of the incident, timeframe of the incident, impact of the incident, severity of the incident, etc. The features may be quantified and represented by the RCA data.

The vectors module 114 is configured and operable to further process the RCA data and transform RCA data into vectors that can be utilized for advanced analytical processes such as AI/ML modeling. In some embodiments, the vectors module 114 converts the standardized RCA data into numerical or categorical representations suitable for vectorization, identifies and selects relevant features from the RCA data to be included in the vectors, constructs vectors based on selected features from the RCA data, optionally adjust the dimensionality of the vectors, normalizes vector values to ensure they are within a consistent range, encodes categorical data into numerical formats suitable for vector representation, and validates that vectors accurately represent the RCA data.

In some embodiments, the vectors may be embeddings representing real-world objects, such as words, images, or videos, in a form that computers can process. Embeddings can be used to represent various types of data, such as incident descriptions, device types, and network conditions. In some embodiments, the embeddings may be generated based on the textual data, categorical data, network metrics data. In some embodiments, the embeddings can be combined with other numerical features to create a composite vector.

The vector database 116 is configured to store the vectors and embeddings generated by the vectors module 114. The vectors and embeddings stored in the vector database can allow for advanced analytical techniques, such as clustering similar incidents, identifying patterns, and predicting potential future network incidents. Large datasets can be generated based on the vectors and embeddings, and the datasets may be learned by various generative AI (GenAI) models, such as those used in natural language processing (NLP) to make inferences, predictions, and generate new content. Vector database 116 may be a centralized database specific to the network service provider and configured to store and manage high-dimensional data and allow for efficient storage, retrieval, and processing of vectors, which facilitates high-performance AI applications.

The data fabric module 118 is configured and operable to manage and integrate RCA data and network data from various sources across the network service provider. In some embodiments, the data fabric module 118 connects and integrates RCA data and network data from disparate sources, such databases, data lakes, cloud services, and on-premises systems. The data fabric module 118 can also integrate RCA data associated with different RCA documents and network data associated with different network incidents. The data fabric module 118 can automate the movement, transformation, and processing of RCA data and network data and supports real-time data processing and batch data workflows. In some embodiments, after the data pre-processing module 112 extracts and standardizes the relevant information and generates RCA data, the data fabric module 118 can orchestrate the flow of RCA data into the vectors module 114 for further processing and vectorization. The data fabric module 118 also implements pre-established network policies, data quality requirement, and security protocols for data integration and federation. The data fabric module 118 also provides necessary data infrastructure and tools and orchestrates the use of vectorized RCA data in advanced analytical processes, such as AI/ML models. The data fabric module 118 is operable to remove redundancy of the data and verify that no data replication occurs within the network analysis platform 102.

In the illustrated example, the query analytical system 120 further includes, among other components, a query processing module 122, an RCA assistance module 124, and an output module 126. The query processing module 122 is configured and operable to receive and process a query sent from a network operator via an interface. The query may be a prompt, a ticket, a notification, or a request for response. For example, the query may include a request for relevant RCA data, features, network data, or other information related to one or more pre-established RCA documents stored in the RCA database 142. For another example, the query may include a suspicious network anomaly and a request for verifying the network anomaly. For another example, the query may further include a request for identifying the type of the anomaly and determining the root cause of the network anomaly.

The RCA assistance module 124 is an AI-empowered and generative module configured and operable to process the query, obtain data relevant to the query, generate content in response to the query, and perform an RCA process. In some embodiments, the RCA assistance module 124 further includes a retrieval-augmented generation (RAG) orchestrator operable to enhance the use of AI/ML models by integrating information retrieval techniques with generative models. The RGA orchestrator can perform searches on larger dataset or databases to identify the most relevant data and pieces of information based on a query and uses the retrieved information to generate coherent and contextually appropriate responses or content. The RGA orchestrator can also direct queries and the associated data to the AI/ML models 138 and facilitate the transmission and delivery of the AI-generated data by the AI/ML system 106. The native support of RGA orchestrator allows to use the data specific to a network service provider as context of the queries to the AI/ML system 106 without need to fine-tune or create new telecommunications-specific models. The AI/ML models 138 used by the RGA orchestrator can be stateless and the data specific to the network service provider is not persisted in the AI/ML system 106 and the AI/ML models 138.

In some embodiments, the RCA assistance module 124 is cloud native and microservices based and supports both horizontal and vertical scaling based on demand. The RCA assistance module 124 can support deployment on a cloud-computing platform such as Amazon Web Services (AWS) or any other cloud platform such as Azure, Google Cloud Platform, IBM Cloud, among others.

In some embodiments, the RCA assistance module 124 employs the AI/ML models 138 provided by the AI/ML system 106 to process the query. In some embodiments, the RCA assistance module 124 is operable to receive and interprets a query using a LLM 139 or other natural language processing (NLP) techniques to understand the intent and specifics of the query, analyze the data included in the query, retrieve/obtain relevant data required to address the query from various sources, such as the network database 144 and the RCA database 142, vector database 116, generate contents in response to the query by synthesizing the retrieved data and applying the AI/ML models, produce explanations, summaries, or detailed analyses as needed, depending on the type of the query.

In some embodiments, the query pertains to historical network incidents, such as network incident aggregation, key insights from past RCAs, incident trends analysis, vendor performance history and prediction, etc. Examples of the query/prompt in this category include but are not limited to: “Provide a summary of all incidents with impact and RCA that occurred within the last week in the southern region and provide resolution status;” “What are the most commonly impacted regions;” “What are the most commonly impacted regions in 2024;” “What are the chronic incidents occurring in the southern region in the last 40 days;” “What incidents correspond to the software defect issue;” “What are the most frequently occurring issues;” “What are the most commonly impacted services;” “Retrieve all incidents by MTTR and incident numbers.” The RCA assistance module 124 analyzes the query and generate contents in response to the query, using the AI/ML models 138.

In some embodiments, the query includes a request for incident level analysis and elicits a response from the RCA assistance module 124 that provides more detailed information related to specific network incidents. Examples of the query/prompt in this category include but are not limited to: “What is the specific incident impact summary: impacted node, service/KPI, region/AOI/cluster, times/duration, impacted subscriber base?” “What is the specific incident RCA summary?” What is the specific incident flow summary for INCWLS0590790 (e.g. involved team, dispatch times, resolution time)” “What are the types of incidents which are similar to INCWLS0590790?” The RCA assistance module 124 analyzes the query and generate contents in response to the query, using the AI/ML models 138.

In some embodiments, the query includes a request for root cause analysis, and the RCA assistance module 124 is operable to automatically analyze the query, verify a suspicious anomaly provided in the query, identify one or more anomalies based on the data provided in the query and/or retrieved from other sources, and determine one or more root causes for the identified anomalies, using the AI/ML models 138. For example, the anomalies can be identified based on deviations from predetermined normal/acceptable data patterns, deviations from predetermined normal/acceptable network usage, derivations from predetermined normal/acceptable network performance, and/or specific fault indicators from the network data associated with the anomalies. Once anomalies are identified, the RCA assistance module 124 may employ techniques in the AI/ML models, such as pattern recognition, causal inference, and historical data comparison to determine the exact root causes of the anomalies.

In some embodiments, the query includes a request for recommendations on a prompt network incident and elicits a timely response from the RCA assistant module 124 that provides process optimizations, identification/verification of anomalies, recommendations on how to address problematic software, hardware, and processes. Examples of the query/prompt in this category include but are not limited to: “What are some preventive measures that can be taken to avoid future occurrences of incident INCWLS0590790 or similar incidents?” “Recommend how to resolve incident INCWLS0590790 or a similar incident.” The RCA assistance module 124 analyzes the query and generate contents in response to the query, using the AI/ML models 138.

The output module 126 is configured and operable to generate a response/output to the query and present the response/output to the user. The response/output may include the content generated by the RCA assistance module 124 using the AI/ML models 138. The content includes relevant information identified to be responsive to the query. In some embodiments, the response/output is generated using an optimized/personalized semantic and organizational format specific to the user based on the user preferences. The output module 126 presents the response/output to the user through various user interfaces, such as web portals, dashboards, or specific applications.

In some embodiments, the output module 126 can generate an RCA report or RCA output in response to a request included in the query using the AI/ML models 138. The RCA report may include the identified anomalies, root cause analysis, and recommendations on the preventive/corrective actions. The output module 126 presents the RCA report to the user through the user interface.

In the illustrated example of FIG. 1, the AI/ML system 106 includes, among other components, a communications module 132, an AI/ML training module 134, an AI/ML analytical module 136. The AI/ML analytical module 136 further includes one or more AI/ML models 138. The AI/ML models 138 may further include one or more LLMs 139. The AI/ML system 106 may be implemented on a cloud-computing platform and within a secured cloud environment. The communications module 132 is configured and operable to facilitate data transmission between the network analysis platform 102 and the AI/ML system 106. In some embodiments, the communications module 132 receives RCA documents, RCA data, vectors, features, and other data related to RCA documents from the RCA analytical system 110 through a connection 162. The connection 162 may be secured for protection of the data. For example, the data may be encrypted by the RCA analytical system 110, transmitted to AI/ML system 106, and decrypted by the communication module 132. The data related to RCA are only used for the purpose of constructing and training the AI/ML models 138 but not persisted within the AI/ML system 106, which adds another layer of protection on the data.

Similarly, the communications module 132 receives queries and data associated with queries from the query analytical system 120 and send data generated by the AI/ML system 106 to the query analytical system 120 through a connection 164. The data transmitted through the connections 162 and 164 may be protected by using encryption-decryption protocols or other security techniques such as zero-trust security.

The AI/ML training module 134 is configured and operable to establish, develop, train, validate, and update one or more AI/ML models 138 used by the AI/ML analytical module 136 or other components within the system 100. In some embodiments, the AI/ML training module 134 may construct one or more generative adversarial network (GAN) or a similar generative AI model using historical RCA data and/or network data. However, various other types of AI/ML models may be trained and deployed without deviating from the scope of the present disclosure. The AI/ML models 138 may further include an anomaly identification model, a diagnostic model. A predictive model, and other models configured to perform a specific intended function.

Upon request by the query analytical system 120, the AI/ML analytical module 136 can operate in conjunction with the RCA assistance module 124 to analyze the query and generate content responsive to the query using the AI/ML models 138 stored in the AI/ML system 106. For example, the AI/ML analytical module 136 integrates various data associated with the query and provided by the RCA assistance module 124 to create a comprehensive context, selects appropriate AI/ML models 138 for analyzing the query, processes the integrated data using the selected models, generates contents responsive to the query, including insights from anomaly identification, root cause analysis, explanations on the root cause, predictions, and recommended actions. The AI/ML analytical module 136 may transmit the contents to the RCA assistance module 124 through the secured connection 164.

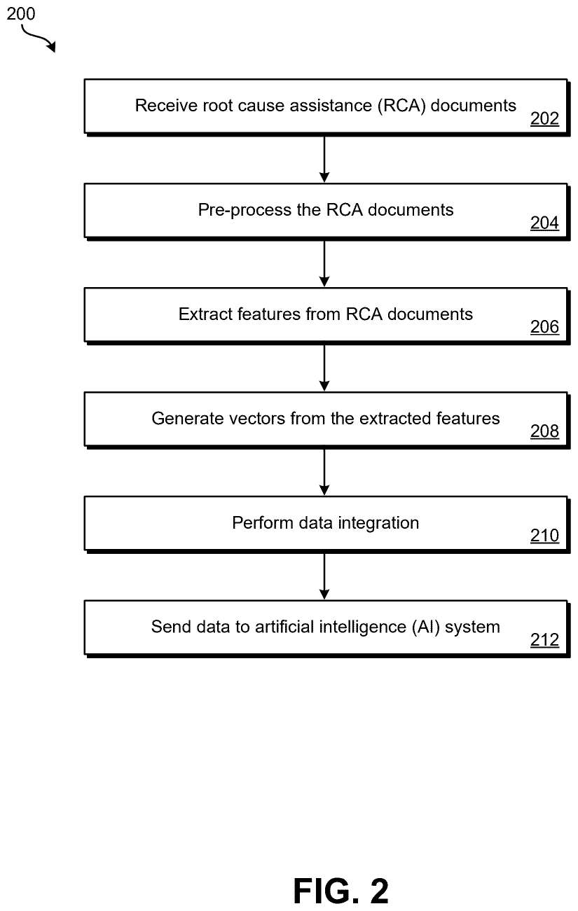

FIG. 2 is a flow diagram illustrating an example method 200, according to various embodiments of the present disclosure. Method 200 may be performed by system 100 or any one or more components included therein. Method 200 may include one or more process blocks illustrated in FIG. 2. However, fewer or additional process blocks may be included in method 200. The sequence of the process blocks illustrated in FIG. 2 may vary. One or more process blocks of method 200 may be combined with one or more process blocks of other methods described in the present disclosure in a suitable manner.

At 202, historical RCA documents are received, in an RCA analytical system. The RCA documents may be specific to a network service provider. Each one of the historical RCA documents includes description of a network incident or anomaly (e.g., type, geolocation, timeframe, etc.), a root cause analysis for the incident or anomaly, an impact of the incident or anomaly, a resolution to the incident or anomaly, and a recommendation on preventing the incident or anomaly. The historical RCA document may further include historical network data associated with the RCA document or the location of the network data.

At 204, the RCA documents are preprocessed, by the RCA analytical system, to extract relevant information from the RCA documents and data streams, retrieve network data associated with the RCA document, eliminate irrelevant or redundant information, generate RCA data, standardize the data formats of the RCA data, and validate the RCA data.

At 206, one or more features are extracted from the RCA data, by the RCA analytical system. The features may follow a standardized format and represent various aspects of the incident or anomaly included in the RCA documents.

At 208, a vectorization process is performed, by the RCA analytical system, to generate one or more vectors based on the RCA data and the extracted features. In some embodiments of the vectorization process, the extracted features are transformed into one or more numerical vectors, and the RCA data may be transformed into a format suitable for quantitative comparisons and modeling by AI/ML models. Optionally, the dimensionality of the vectors may be adjusted to improve computational efficiency. The generated vectors are validated to accurately represent the RCA data and capture the relevant information.

At 210, a data integration process is performed, by the RCA analytical system, to integrate RCA data associated with different RCA documents and/or network data associated with different network incidents, remove redundancy of the RCA data and/or network data, orchestrate the flow of RCA data and/or network data, and implement pre-established network policies, data quality requirement, and security protocols for data transmission, integration, and federation.

At 212, the RCA data and vectors are provided to an AI/ML system for constructing and training one or more AI/ML models. The AI/ML models may include one or more LLMs. The RCA data and vectors may be transmitted to the AI/ML system through a secured connection between the RCA analytical system and the AI/ML system.

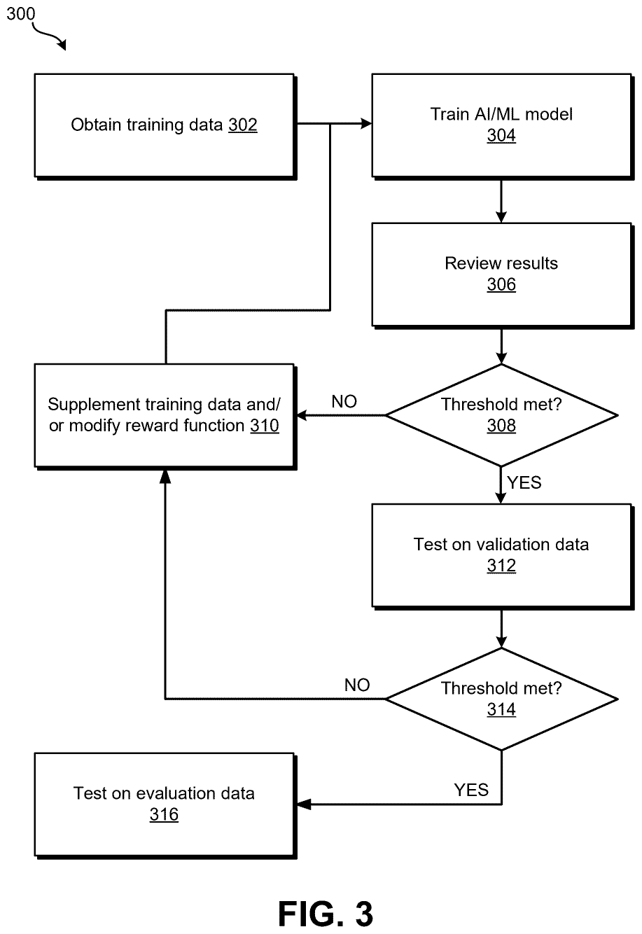

FIG. 3 is a flow diagram illustrating an example method 300 for training AI/ML model(s) specific to a network service provider, according to various embodiments of the present disclosure. Method 300 may be performed by the AI/ML system 106 or any one or more components included therein. One or more process blocks of method 300 may be combined with one or more process blocks of other methods described in the present disclosure in a suitable manner.

At 302, RCA data are obtained/received in the AI/ML system. The RCA data encompasses the historical RCA documents, standardized RCA data, extracted features, and vectors generated by and transmitted from the RCA analytical system. The RCA data may be split into a set of training data and a set of evaluation/validation data. The training data may be labeled or unlabeled. The nature of the training data that is provided will depend on the objective that the AI/ML model is intended to achieve. The AI/ML model is then trained over multiple epochs at 304 and results are reviewed at 306. If the AI/ML model fails to meet a desired confidence threshold at 308, the training data is supplemented and/or the reward function is modified to help the AI/ML model achieve its objectives better at 310 and the process returns to step 304. If the AI/ML model meets the confidence threshold at 308, the AI/ML model is tested on evaluation/validation data at 312 to ensure that the AI/ML model generalizes well and that the AI/ML model is not over fit with respect to the training data. The evaluation data includes information that the AI/ML model has not processed before. If the confidence threshold is met at 314 for the evaluation data, the AI/ML model is deployed at 316. If not, the process returns to step 310 and the AI/ML model is trained further.

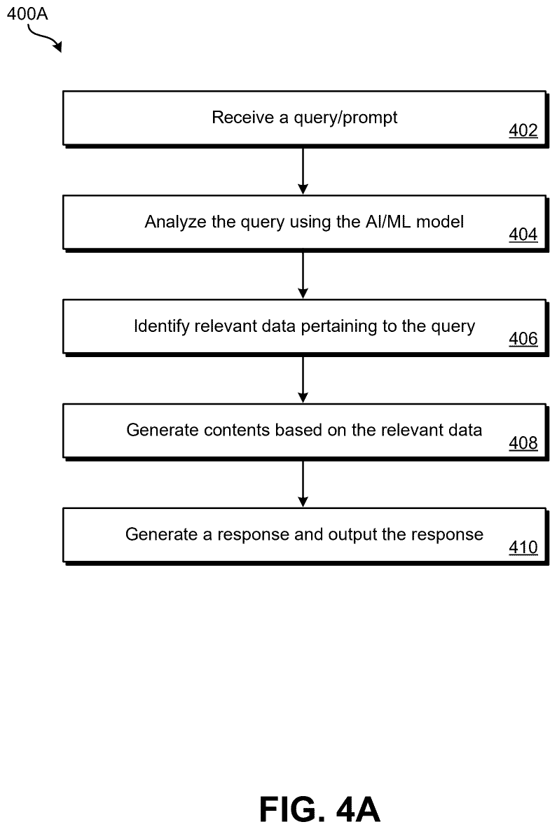

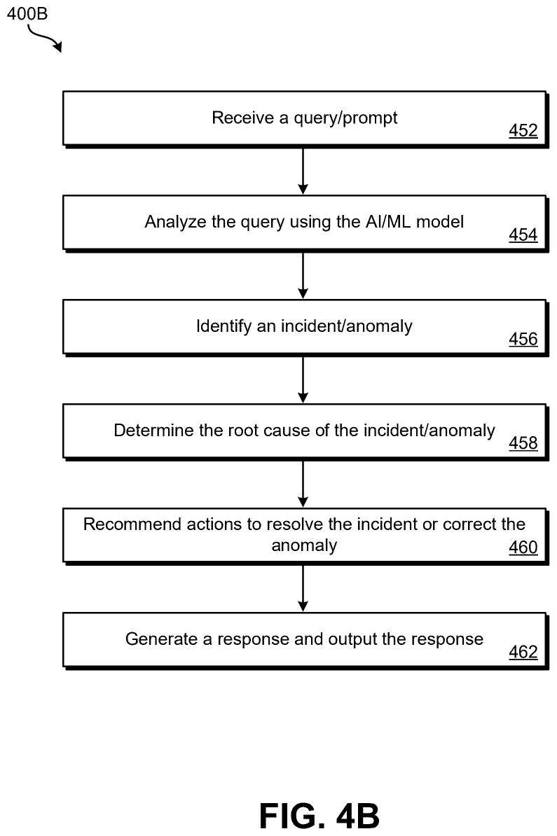

FIG. 4A is a flow diagram illustrating an example method 400A for automatic network incident analysis, according to various embodiments of the present disclosure. Method 400A may be performed by the query analytical system 120 in conjunction with the AI/ML system 106. Method 400A may include one or more process blocks illustrated in FIG. 4A. However, fewer or additional process blocks may be included in method 400. One or more process blocks of method 400A may be combined with one or more process blocks of other methods described in the present disclosure in a suitable manner.

At 402, a query/prompt from an operator of a network service provider is received, in the query analytical system of a network analysis platform. At 404, the query is processed/analyzed by the query analytical system using the AI/ML models constructed and trained by an AI/ML system based on historical RCA data. One or more intents are extracted from the query. At 406, historical RCA data pertaining to the extracted intents are identified, located, and/or retrieved by the query analytical system. At 408, contents are generated by the query analytical system using the AI/ML model, based on the identified historical RCA data. The contents include description of the relevant data and information responsive to the query. In some embodiments, the query and the historical RCA data are transmitted to the AI/ML system from the query analytical system through a secured connection. The AI/ML system analyzes the query, identifies pertaining RCA data, and generates the contents using the AI/ML models stored therein, and transmits the contents back to the query analytical system. At 410, a response including the contents is generated and output to the operator, by the query analytical system.

FIG. 4B is a flow diagram illustrating an example method for automatic network incident identification and root cause analysis, according to various embodiments of the present disclosure. Method 400B may be performed by the query analytical system 120 in conjunction with the AI/ML system 106. Method 400B may include one or more process blocks illustrated in FIG. 4B. However, fewer or additional process blocks may be included in method 400. One or more process blocks of method 400B may be combined with one or more process blocks of other methods described in the present disclosure in a suitable manner.

At 452, a query/prompt from an operator of a network service provider is received, in the query analytical system of a network analysis platform. In some embodiments, the query indicates a suspicious network incident or anomaly and includes network data pertaining to the suspicious network incident or anomaly. The query further elicits a root cause analysis.

At 454, the query is analyzed, by the query analytical system in conjunction with an AI/ML system in conjunction with the query analytical system, using one or more AI/ML models trained by the AI/ML system based on historical RCA data. The query and/or network data are analyzed to extract one or more features such as the pattern of the network data, performance metrics, configuration settings, or other relevant parameters. The AI/ML models can be used to analyze the extracted features to identify patterns and correlations indicative of potential root causes. The analysis may include comparing the current network data with historical data to detect similarities or anomalies.

At 456, one or more network incidents/anomalies are verified or identified, by the query analytical system using the AI/ML models. For example, a deviation of network usage data from a predetermined normal usage is calculated to exceed a predetermined level, and a predetermined type/class of anomaly correlating/corresponding to the deviation is identified using the AI/ML models.

At 458, one or more root causes of the identified network incident are determined, by the query analytical system using the AI/ML models. The AI/ML models have been trained to recognize patterns, correlations, and causality relationships between various network data metrics and historical network incidents. The AI/ML models can be used to infer potential causal relationships between the identified anomalies and the root causes of the network incident, based on data such as the timing of incidents, the sequence of actions, and the impact on network performance. Multiple candidate root causes may be determined, and a probability or confidence score may be assigned to each candidate root cause. Based on the analysis results and probabilistic assessment, one or more root causes of the network incident may be recommended by the query analytical system to the network operator. The root causes may include factors such as hardware failures, software bugs, misconfigurations, or unexpected events. The root causes may be further validated against known patterns and historical RCA data or network data before output.

At 460, one or more actions are recommended, by the query analytical system using the AI/ML models, to resolve the incident or cure the anomaly. The actions may include specific configuration changes, software updates, network reconfigurations, security measures, or other operational procedures. At 462, a response indicating the identified network incident or anomaly, the determined root causes, and/or the recommended actions is generated and output to the operator, by the query analytical system.

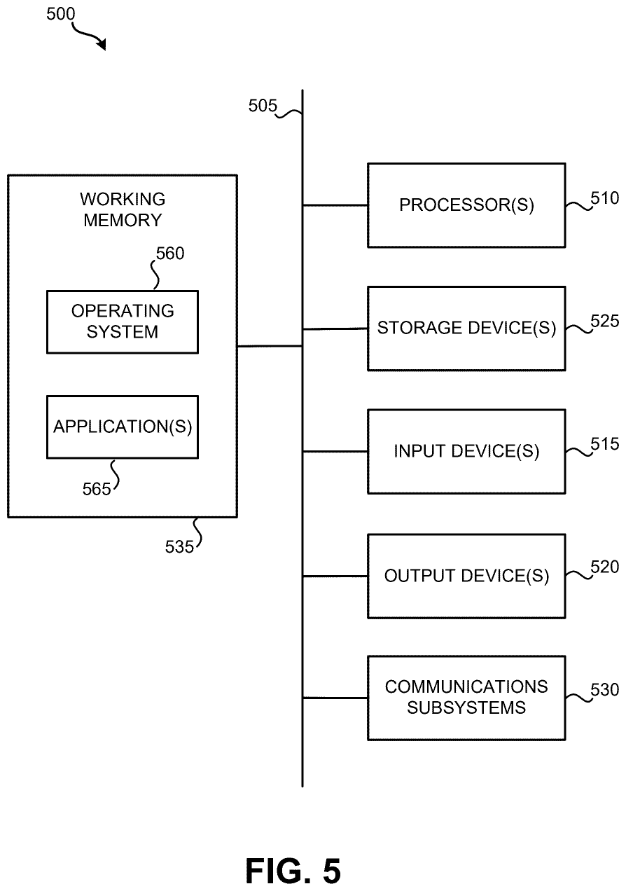

The system 100 or any components thereof, such as the network service provider system 103, the RCA analytical system 110, the query analytical system 120, the AI/ML system 106, etc., described above may include a computer system that further includes computer hardware and software that form special-purpose network circuitry to implement various embodiments such as communication, generation of data, determination, identification, calculation, performing a process or other process blocks of the methods described herein. FIG. 5 is a schematic diagram illustrating an example of computer system 500. The computer system 500 is a simplified computer system that can be used to implement various embodiments described and illustrated herein. FIG. 5 provides a schematic illustration of one embodiment of a computer system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown including hardware elements that can be electrically coupled via a bus 505, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in one embodiment, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, and the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. In one embodiment, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may, in one embodiment, be stored on a non-transitory storage device 525 either before or after execution by the processor(s) 510.

FIG. 6 illustrates a system 600 for analyzing error logs for network analysis, according to certain embodiments. The system 600 may include a computing system 602 with machine learning models (MLMs) 604a-c. The machine learning models 604a-c may be implemented in a machine learning module, or may be implemented as separate services. In some embodiments, some of the MLMs 604a-c and/or the operations performed by each of the MLMs 604a-c may be combined.

The computing system 602 may be similar to some or all of the system 100 in FIG. 1. For example, the computing system 602 may include components such as the network analysis platform 102, the network service provider system 103, network operator(s) 104, and the AI/ML system 106. In other words, the computing system 602 may be a component of a larger system for determining root causes for issues experienced in a telecommunications network. The computing system 602 may include one or more physical and/or virtual machines working in conjunction with one another in order to perform the techniques described herein.

The MLM 604a may include a large language model (LLM), a natural language processor (NLP), a convolutional neural network (CNN), recurrent neural network (RNN), etc. and/or any other suitable models for identifying and extracting various features in text-based logs. The MLM 604a may be trained to extract certain features from the various error logs by parsing an error log and identifying features related to issues experienced by components of a telecommunications network 603. Thus, when an error log (e.g., a log 608) is received from the telecommunications network 603, the MLM 604a may identify important features from the log 608 that may be used to determine a root cause of an issue or incident. The log 608 may include automatically generated data and/or data generated by a technician. The features may include geographical data, user equipment data (e.g., phone numbers, device identifiers, etc.), an error type (e.g., call fail, address not found, etc.). an error rate, component failure data (e.g., which component(s) failed), and/or any other relevant data. The MLM 604a may then generate inputs 610 to be provided to the MLM 606b.

The MLM 606b may include one or more artificial intelligence (AI) engines configured to determine a root cause of the incident by analyzing the inputs 610 and/or other data. The MLM 606b may include models such as a deep neural network (DNN), a CNN, a RNN, a long short term memory model (LTSM), and/or other models. The MLM 606b may be trained to correlate the inputs 610 in order to determine a likely root cause of the issue. The MLM 606b may also be trained to predict failures based on some or all of the inputs (e.g., using predictive maintenance techniques). Thus, the system 600 may be able to analyze network data of the telecommunications network 603 to prevent incidents from occurring.

The MLM 606b may generate a root cause analysis response (RCA) 612 and provide the response to the MLM 606c. The MLM 606c may include one or more AI engines and/or rules based filters. The MLM 606c may compare the RCA 612 to historical incident data 605. The historical incident data 605 may include data indicating previous network incidents, causes, symptoms, etc., as well as instructions for addressing the incidents. If, for example, an incident indicated in the log 608 has been experienced before, the MLM 606c may identify data within the historical incident data 605 that may address the incident. By contrast, if the incident has not been experienced before, the MLM 606c may identify related incidents and infer a corrective action. In any case, the MLM 606c may generate an output 614. The output 614 may indicate the incident, affected components of the telecommunications network 603, affected UEs, and/or an action to be taken to address the incident.

In some embodiments, the output 614 may include executable instructions to address the incident. For example, a software component of the telecommunications network 603 may be responsible for the incident. The MLM 606c (or some other component of the computing system/machine learning module) may then access and/or generate computer code (e.g., using generative AI) to address the issue. The output 614 may then be transmitted to a computing system such that when the code is executed, the problem may be addressed. The output 614 may additionally or alternatively be provided to one or more technicians or other responsible parties.

FIG. 7 illustrates a flowchart of a method 700 for determining a root cause of a telecommunications network incident, according to certain embodiments. The steps of the method 700 may be performed by some or all of the systems described herein, such as the system 100, the system 600, etc. The steps of the method 700 may be performed in a different order than is shown here, and/or may be combined with other steps. In some embodiments, some steps may be skipped altogether.

At step 702, the method 700 may include receiving, by a computing system, an error log indicating an incident within a telecommunications network. The computing system (e.g., the computing system 602) may include one or more physical and/or virtual machines. The error log (e.g., the error log 608) may indicate the incident and/or characteristics of the incident (e.g., datapoints). The characteristics may include geographical data, user equipment data (e.g., phone numbers, device identifiers, etc.), an error type (e.g., call fail, address not found, etc.). an error rate, component failure data (e.g., which component(s) failed), and/or any other relevant data. The error log may be received by the computing system (e.g., the error log may be pushed to the computing system), and/or the computing system may monitor the telecommunications network and generate the error log.

At step 704, the method 700 may include providing, by the computing system, the error log to a machine learning module (MLM), the MLM configured to determine a root cause of the incident. The MLM may be implemented on the computing system or may be implemented on some other computing system. The MLM may include one or more machine learning models and/or AI engines configured to perform various functions to determine a root cause of the incident. The MLM may include an LLM, NLP, CNN, RNN, LTSM, and/or any other suitable ML/AI model. The MLM may also include one or more rules based filters.

At step 706, the method 700 may include parsing, by the MLM, the error log to identify one or more datapoints (e.g., by the MLM 604a). For example, the MLM may include an LLM and/or NLP. The MLM may then parse the error log to identify one or more features (datapoints) associated with the incident. The MLM may then utilize the datapoints as inputs for a second machine learning model/AI engine.

At step 708, the method 700 may include determining, by the MLM, a root cause of the error by utilizing the one or more datapoints as inputs to an artificial intelligence engine configured to associate the one or more datapoints with the root cause. The AI engine may be similar to the MLM 604b in FIG. 6. Thus, the MLM 604b may include an CNN, an RNN, an LTSM, and/or any other model suitable for inferring a root cause from various inputs. The MLM 604b may generate a root cause analysis output (e.g., the RCA 612) indicating the root cause (or a likelihood thereof), the incident, and/or other such data.

At step 710, the method 700 may include determining, by the MLM, a corrective action to be taken such that the incident is addressed. The MLM may determine the corrective action utilizing a rules based filter or other such technique/system (e.g., the MLM 604c). The MLM may compare the root cause to historical incidents and corrective actions taken to address the root causes of the incidents. In some embodiments, the MLM may identify related incidents within the historical incidents/corrective actions and infer a corrective action to the incident indicated in the error log.

The methods, systems, and devices discussed above are examples. Various configurations may omit, substitute, or add various procedures or components as appropriate. For instance, in some embodiments, the methods may be performed in an order different from that described, and/or various stages may be added, omitted, and/or combined. Also, features described with respect to certain configurations may be combined in various other configurations. Various embodiments of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the embodiments of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “an RCA document” includes a plurality of such RCA documents, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A computer system comprising:
one or more processors; and
a computer-readable storage media storing computer-executable instructions, wherein the computer-executable instructions, when executed by the one or more processors, cause the computer system to perform:
receiving historical root cause analysis (RCA) documents specific to a network service provider;
receiving network data associated with the RCA documents;
processing the RCA documents to generate RCA data based on the RCA documents and the network data;
generating one or more vectors based on the RCA data; and
constructing and training one or more AI models based on the RCA data.

2. The computer system of claim 1, wherein the instructions when executed by the one or more processors, further cause the computer system to perform:
receiving a query from a network operator of the network service provider;
identifying one or more of the historical RCA documents pertaining to the query using the AI models;
analyzing the query using the AI models to extract one or more intents of the network operator;
generating contents using the AI models, the contents comprising data associated with the identified historical RCA documents and pertaining to the extracted intent; and
generating a response comprising the contents for output.

3. The computer system of claim 1, wherein the instructions when executed by the one or more processors, further cause the computer system to perform:
receiving a query from a network operator of the network service provider, the query indicating a suspicious network incident and including network data pertaining to the suspicious network incident;
identifying/verifying one or more network incidents using the AI models, based on the network data;
determining one or more root causes of the identified/verified network incidents using the AI models;
recommending one or more actions to resolve the network incidents; and
generating a response for output.

4. A method for determining a root cause of a cellular network errors, comprising:
receiving, by a computing system, an error log indicating an error within a cellular network;
providing, by the computing system, the error log to a machine learning module (MLM), the MLM configured to determine a root cause of the error by:
parsing, by the MLM, the error log to identify one or more datapoints;
determining, by the MLM, a root cause of the error by utilizing the one or more datapoints as inputs to an artificial intelligence engine configured to associate the one or more datapoints with the root cause; and
determining, by the MLM, a corrective action to be taken such that the error is corrected; and
outputting, by the computing system, data indicating at least one of the error, the root cause, or the corrective action.

5. The method of claim 4, wherein the MLM comprises at least one of a large language model or a support vector machine.

6. The method of claim 4, wherein the artificial intelligence engine comprises a neural network.

7. The method of claim 4, wherein the error log comprises at least one of geographic data, software data, hardware data, user equipment (UE) data, an error type, or an error rate.

8. The method of claim 4, further comprising:
receiving, by the computing system, retraining data based at least in part on the data indicating at least one of the error, the root cause, or the corrective action; and
providing, by the computing system, the retraining data to the MLM such that one or more nodes of the MLM are reconfigured, and an accuracy of the MLM is increased when determining a future root cause.

9. The method of claim 4, wherein the MLM comprises a large language model (LLM), the method further comprising:
receiving, by the computing system, a training dataset comprising historical error logs;
generating, by the computing system, a modified training dataset wherein the modified training dataset comprises transformed data of the training dataset;
vectorizing, by the computing system, the training dataset and the modified training dataset to generate a preprocessed dataset; and
providing, by the computing system, the preprocessed dataset to the MLM such that an accuracy of the LLM is increased when parsing a future error log.

10. The method of claim 4, further comprising:
generating, by the MLM, instructions based at least in part on the output indicating the corrective action; and
transmitting, by the computing system, the instructions to one or more network components such that upon execution of the corrective action, at least a portion of the root cause is resolved.

11. The method of claim 10, wherein the MLM comprises a generative AI model.

12. The method of claim 4, further comprising:
determining, by the MLM, one or more network components associated with the root cause;
determining, by the MLM, a respective entity associated with each of the one or more network components; and
transmitting, by the computing system, the data to the respective entities.

13. A system for analyzing error logs, comprising:
one or more processors; and
a computer-memory comprising instructions that, when executed by the one or more processors, cause the system to:
receive, by a computing system, an error log indicating an error within a telecommunications network;
provide, by the computing system, the error log to a machine learning module (MLM), the MLM configured to determine a root cause of the error by:
parse, by the MLM, the error log to identify one or more datapoints;
determine, by the MLM, a root cause of the error by utilizing the one or more datapoints as inputs to an artificial intelligence engine configured to associate the one or more datapoints with the root cause; and
determine, by the MLM, a corrective action to be taken such that the error is corrected; and
output, by the computing system, data indicating at least one of the error, the root cause, or the corrective action.

14. The system of claim 13, wherein the MLM comprises at least one of a large language model or a vector support machine.

15. The system of claim 13, wherein the datapoints comprise at least one of geographic data, software data, hardware data, user equipment (UE) data, an error type, or an error rate.

16. The system of claim 13, wherein the telecommunications network comprises a standalone 5G cellular network.

17. The system of claim 13, wherein the artificial intelligence engine comprises a neural network.

18. The system of claim 13, wherein the error comprises a hardware component error, and the computing system determines an entity associated with the hardware component and transmits the data indicating at least one of the error, the root cause, or the corrective action to the entity.

19. The system of claim 13, wherein the instructions further cause the system to:
generate, by the MLM, instructions based at least in part on the output indicating the corrective action; and
transmit, by the computing system, the instructions to one or more network components such that upon execution of the corrective action, at least a portion of the root cause is resolved.

20. The system of claim 19, wherein the MLM comprises a generative AI model.
